(19) United States
(12) Patent Application Publication
(10) Pub. No.: US 2008/0107478 A1
(43) Pub. Date: May 8, 2008

(54) ADJUSTABLE HINGE FOR A CUSHION ON A SOFA

(76) Inventor: Paul Reitzin, Van Nuys, CA (US)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/555,811

(22) Filed: Nov. 2, 2006

(51) Int. Cl. F16C 11/00

(52) U.S. Cl. 403/119

(57) ABSTRACT

An adjustable hinge for a cushion on a sofa has an insertion tube attached under the cushion and a tube holder embedded inside the seat body and rotatably receiving the insertion tube. The insertion tube has multiple notches defined at a distal end thereof and the tube holder has a bar correspondingly engage two of the notches for positioning. Thereby, the adjustable hinge controls the rotation angles of the cushion to change the configuration of the sofa.

### BACKGROUND OF THE INVENTION

1. Field of the Invention

The present invention relates to an adjustable hinge, and more particularly to an adjustable hinge for a cushion on a sofa to operationally adjust rotation angles of the cushion.

2. Description of Related Art

Sofa is a furniture chair that is specially emphasized on its comfortable feeling in use so that a user can completely relax thereon at home. Therefore, the sofa always occupies a great selling proportion in the furniture market and exists in almost every household.

A conventional sofa mostly focuses on selecting nice materials of the sofa or a cushion thereon to achieve the comfortable feeling by providing a buffering function to the user sitting or leaning on the sofa. Although the user can completely relax on the sofa, posture of the user in habit can not be corresponding to the configuration of the sofa with the cushion because the sofa is unadjustable. Therefore, utility flexibility of the conventional sofa is limited to response to user's need.

According to above description, the conventional sofa still has some drawbacks in use and needs to be improved.

### SUMMARY OF THE INVENTION

A main objective of the present invention is to provide an adjustable hinge for a cushion on a sofa that can be conveniently adjusted in rotation angles of the cushion to allow a user changing postures thereon.

To achieve the foregoing objective, the adjustable hinge secured between a cushion and a seat body comprises:

an insertion tube adapted to attached to the cushion and having a distal end and multiple notches defined in the distal end; and

a tube holder with a hole adapted to embed inside the seat body, rotatably receiving the insertion tube and having a bar formed inside the hole to correspondingly engage paired two of the multiple notches for positioning.

By rotating the insertion tube on the cushion corresponding to the tube holder on the seat body, the cushion can be conveniently adjusted to different rotation angles in different situations.

Further benefits and advantages of the present invention will become apparent after a careful reading of the detailed description with appropriate reference to the accompanying drawings.

### BRIEF DESCRIPTION OF THE DRAWINGS

FIG. 1 is a perspective of an adjustable hinge in accordance with the present invention, wherein the adjustable hinge is clamped between a cushion and a seat body;

FIG. 2 is an exploded perspective view of the adjustable hinge in FIG. 1;

FIG. 3 is a perspective view of the perspective view of the adjustable hinge in assembly;

FIG. 4 is a cross-sectional view of the adjustable hinge in FIG. 3;

FIG. 5 is an operational perspective view of the adjustable hinge embedded with the adjustable hinge; and

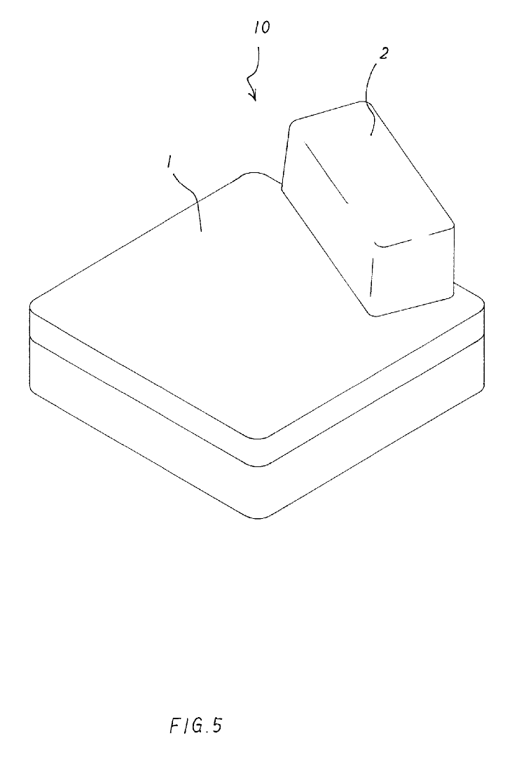

FIG. 6 is a perspective view of another embodiment of the adjustable hinge in accordance with the present invention.

### DETAILED DESCRIPTION OF THE PREFERRED EMBODIMENT

An adjustable hinge for a cushion on a sofa in accordance with the present invention comprises an insertion tube attached under the cushion and a tube holder embedded inside the seat body and rotatably receiving the insertion tube. The insertion tube has multiple notches defined at a distal end thereof and the tube holder has a bar correspondingly engage two of the notches for positioning. Thereby, the adjustable hinge controls the rotation angles of the cushion.

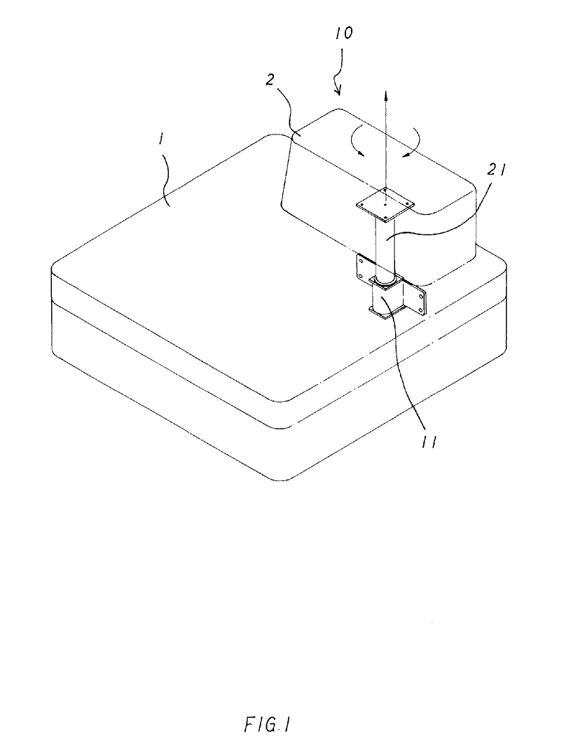

With reference to FIG. 1, a preferred embodiment of the adjustable hinge is attached to a sofa 10 composed of a seat body 1 and a cushion 2.

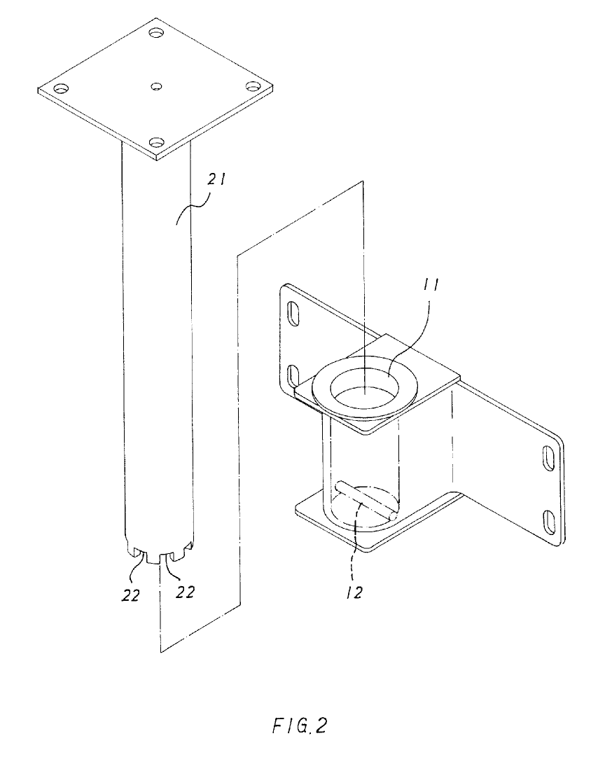

The seat body 1 is served as a sitting place for a user and has a tube holder 11 with a hold embedded inside the seat body 1. The tube holder 11 has a bar 12 diametrically attached inside the hole of the tube holder 11 (as shown in FIG. 2).

The cushion 2 is served as a backrest to allow a user leaning thereon. The insertion tube 21 is vertically embedded inside the cushion 2 and extends out of the cushion 2 to rotatably engage the tube holder 11 in the seat body 1. The insertion tube 21 has a distal end and multiple notches paired in diameter and defined at edge of the distal end.

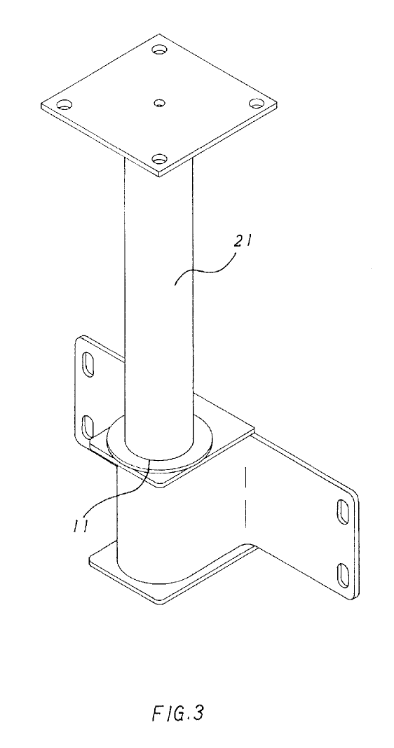

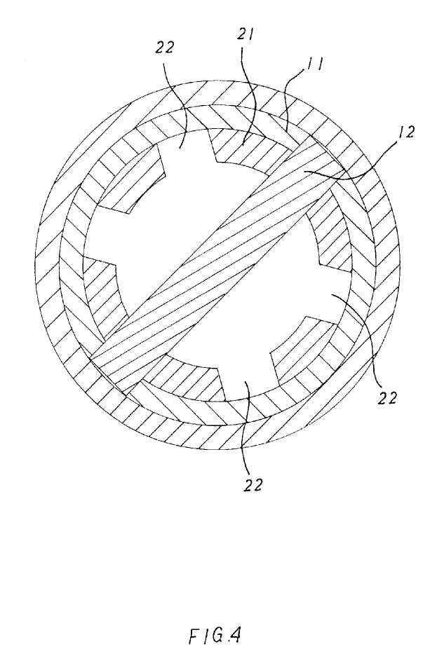

By having the above elements, the cushion 2 in different types enables to combine with the seat body 1 by inserting the insertion tube 21 into the tube holder 11 at a desired place such as at a rear end to serve as a backrest or at one of side ends to serve as an armrest. When the adjustable hinge is assembled, the bar 12 in the tube holder 11 wedges into two paired notches 22 on the insertion tube 21 (as shown in FIGS. 3 and 4) to make the insertion tube 21 and the tube holder 11 locate at different rotation orientations. Thereby, the sofa 10 composed of the seat body 1 and the cushion 2 has different configurations in use to correspond to different postures.

When changing the rotation orientation of the cushion, the insertion tube 21 is pull up to disengage the notches 22 from the bar 12 and then is rotated to a desire angle. After deciding the rotation angle, the insertion tube 21 is pushed downward to engage other paired notches 22 again to keep the cushion 2 in position. Therefore, the sofa 10 can be changed to different configurations by simply rotating the cushion and is applicable to different users or different postures without limitation.

The attachment of the insertion tube 21 to the cushion 2 is preferably located at a center section of the cushion 2, however, the insertion tube 21 also can be mounted at an end of the cushion 2 in another embodiment (now shown) so that the cushion 2 can be moved aside to enlarge the area of the seat body 1. In this embodiment, the efficient area for sitting is variable.

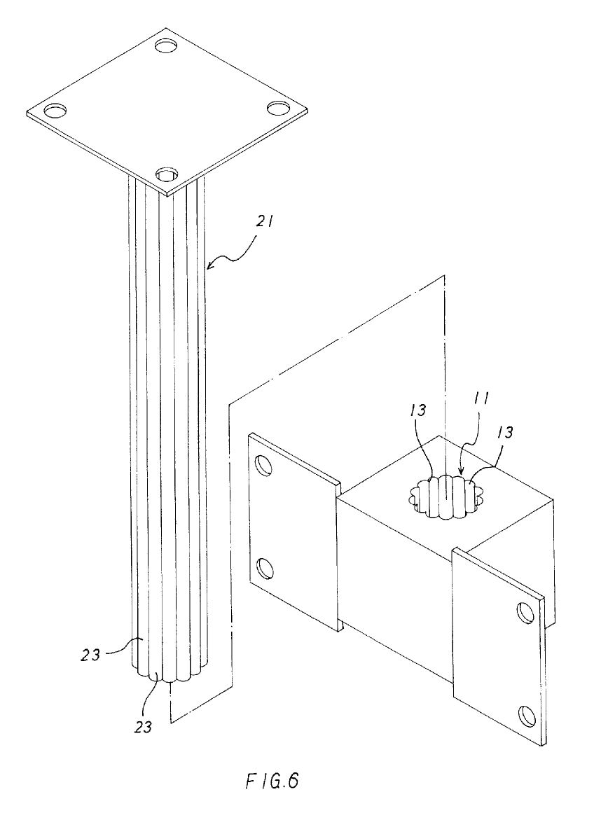

Moreover, still another embodiment of the adjustable hinge has multiple ribs 23 longitudinally formed on periphery of the insertion tube 21 (a shown in FIG. 6) and the tube holder 11 has multiple grooves 13 longitudinally defined on an inner periphery of the hole of the tube holder 11 to correspondingly engage the ribs 23 and to provide the positioning efficiency to the cushion 2.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. An adjustable hinge for a cushion and a seat body on a sofa, the adjustable hinge comprising:
an insertion tube adapted to attached to the cushion and having a distal end and multiple notches defined in the distal end; and
a tube holder with a hole adapted to embed inside the seat body, rotatably receiving the insertion tube and having a bar formed inside the hole to correspondingly engage paired two of the multiple notches for positioning.

2. The adjustable hinge as claimed in claim 1, wherein the insertion tube has multiple ribs longitudinally formed on an outer periphery of the insertion tube;
the tube holder has multiple grooves longitudinally defined on an inner periphery of the tube holder.
